(19) United States
(12) Patent Application Publication
(10) Pub. No.: US 2004/0021687 A1
(43) Pub. Date: Feb. 5, 2004

(54) Method for displaying the operating conditions of an installation

(76) Inventor: Aloys Wobben, Aurich (DE)

Correspondence Address: Neil Steinberg, Steinberg & Whitt, 2672 Bayshore Parkway, Suite 514, Mountain View, CA, 94043, US

(21) Appl. No.: 10/398,431

(22) PCT Filed: Sep. 8, 2001
(86) PCT No.: PCT/EP01/10387

(30) Foreign Application Priority Data
Oct. 14, 2000 (DE) 10050993.2

(51) Int. Cl. G09G 5/00

(52) U.S. Cl. 345/740

(57) ABSTRACT

A method of processing and representing the function of a plurality of installations, characterised by the following steps:

predetermined operating data, in particular those revealing the serviceability of an installation, are acquired in a data processing installation;

the acquired operating data are evaluated and classified;

the classification step includes ascertaining the information as to whether the installation is or is not serviceable and if not, what possible reason there is for the non-serviceability, for example a technical failure, maintenance operations or other reasons;

a symbol is associated with each installation or a group of installations;

the symbol classifies the type of the installation and/or the serviceability of the respective installation;

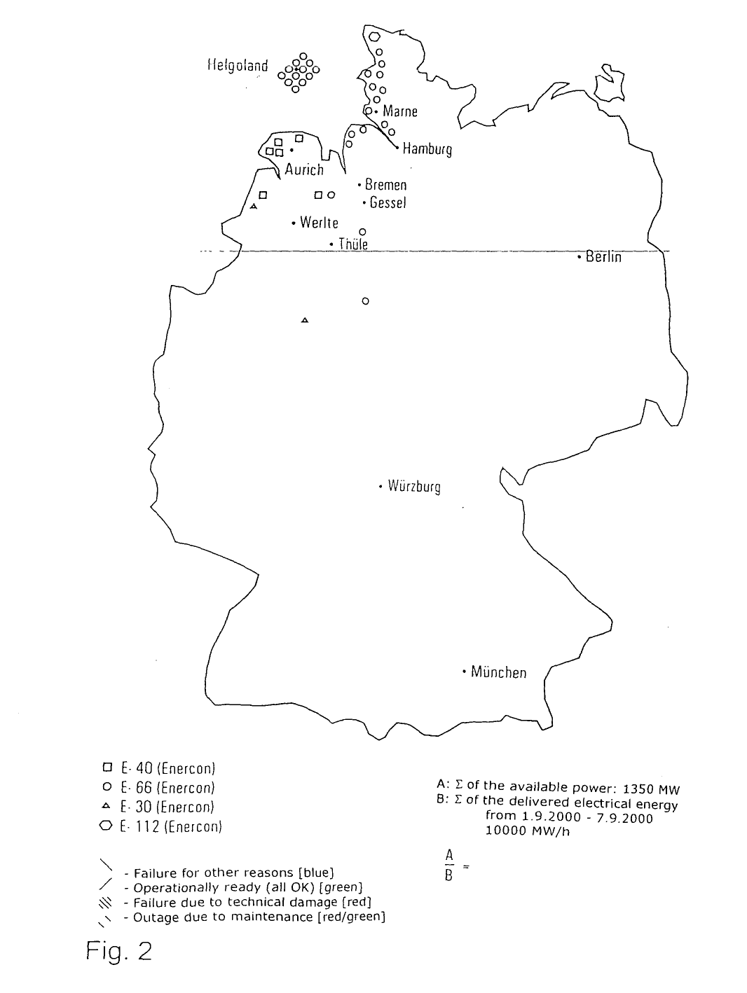

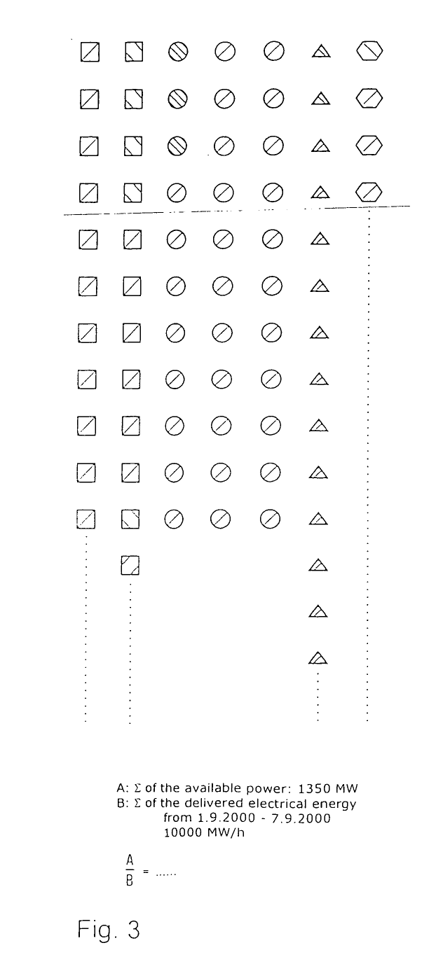

all symbols are combined to afford an overview (FIG. 2, FIG. 3) and are stored as an electronic file and outputted; and

the electronic file is outputted to a network server with which a given address is associated, by way of which it can be dialled to call up the file.

The invention concerns a method of displaying the operating behaviour of installations such as for example wind power installations, water treatment installations, block heating and generating installations, transformer stations, and so forth.

It is known that the operating behaviour of an installation can be continuously detected and the detected data can also be made available to the operator of the installation. If for example the operator of an installation has a suitable telecommunication device (for example a modem), he can obtain information about all relevant data of his installation, for example whether it is in operation, the output power with which it is operating at the present time or whether there is a fault, and if so, what the reason for the fault is, and so forth. It will be appreciated that environmental data at the installation but also other measured data of the installation can also be called up.

Those environmental data in the case of wind power installations can be for example the direction of the wind, the speed of the wind, temperature, and so forth, while in the case of water treatment installations these can be for example levels, temperatures, and so forth.

The above-described solution however is always tailor-made to the customer of the manufacturer, that is to say generally the operator of the installation, and third parties have no possibility of inspecting the data, but this situation involves operating data which are to be kept secret and which should or may not be made available to just anyone.

It is nonetheless desirable also to make certain items of operating data from a plurality of installations, for example the installations of a manufacturer, available to third parties, so that they can have an overview of the reliability of the installations, in which respect nonetheless the wish on the part of the operator of the installation for confidentiality is still satisfied.

The object of the present invention is to provide a technical solution in this respect, which in particular is attractive and which affords a fast possible way of affording an overview relating to sites and/or the operating behaviour of installations.

The object of the invention is achieved with the method set forth in claim 1. Advantageous developments are described in the appendant claims.

The invention is based on the following considerations:

The operating data of installations, for example the installations from a given manufacturer, are logged or acquired. The acquired operating data are classified, for example as to whether the installation is at all ready for operation (whether, in the case of a wind power installation, for example, it is connected to the network) or not. If the installation is not ready for operation, this can be still further classified, for example in such a way that the reason for the non-serviceability/the installation fault is also specified. Non-serviceability can be caused for example by a breakdown in operation—a technical fault (for example a fire in the generator of a wind power installation)—or however also due to ordinary maintenance procedures which have to be carried out from time to time in relation to installations and during which the installations frequently have to be switched off.

If the installation is serviceable, it is possible to specify under some circumstances whether it is or not operating under nominal operating conditions.

The data classified in that way can be assembled together and then optionally associated with the respective geographical position of the respective installation. It will be appreciated that alternatively it is also possible to associate the data with the respective installation itself on the basis of a unique distinguishing feature, such as for example a serial number. In that respect geographical data describing the site of the installation can equally be associated with the installation. Finally a symbol is specified in an overview such as for example a geographical map (for example a map of Germany) for each installation or a group of installations, in which case the nature of the installation and the operating status of the respective installation or a group of installations can be derived from the symbol. In this respect the symbol is automatically derived from the data associated with the installation, in accordance with a predeterminable algorithm.

Thus for example a symbol such as a green circle can signify that the installation is a wind power installation which is (serviceable) in operation while a symbol such as a red circle indicates that the installation is out of operation. The symbol of a red-green circle (a red semicircle and a green semicircle are put together to form a circle) can indicate that the installation is admittedly basically serviceable but is switched off by virtue of maintenance operations.

The overview provided in that way can identify various kinds of installations and is constantly updated, stored in the form of an electronic file and made available in an information network, for example an Internet network, and made available for being called up by way of an Internet domain address, for example by way of the address of the installation manufacturer.

Now anyone who has Internet access can obtain a picture of the entire ‘fleet’ of installations produced by the installation manufacturer, within a given geographical area, for example within Germany. In that case he not only learns where such installations are disposed but also what the respective operating condition thereof is, that is to say whether the installation is in operation or whether it is not operating satisfactorily by virtue of an operational disturbance.

It is also advantageous not only to associate still further data with an operating site of an installation but also to already represent it on the map. Such data can be for example the operating times of a given past period of time, for example the past month, the last year and so forth, so that the person viewing it also has a highly informative picture about the reliability of an installation.

Thus, by virtue of the constantly updated acquisition of operational data, it is possible by way of a network such as for example the Internet for anyone to obtain online a continuously updated map which also shows the viewer the serviceability of a plurality of installations in a given geographical area, and this is always on an up-to-date basis (or up-to-date in the context of a day or a week).

The invention is described in greater detail by means of an embodiment with reference to the drawings in which:

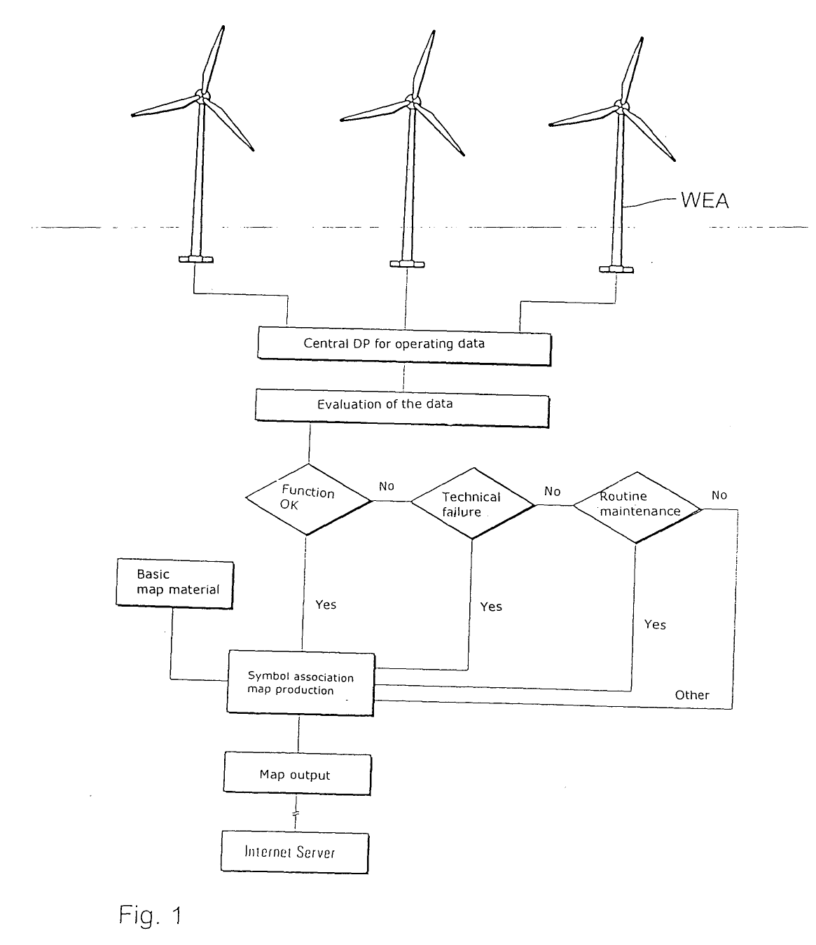

FIG. 1 shows a structure in principle for producing a map,

FIG. 2 shows an embodiment of a map, and

FIG. 3 shows an alternative representation in relation to FIG. 2.

FIG. 1 symbolically shows a number of N installations, wind power installations (WEA) being considered in the example hereinafter. This is to involve all or at least a given part of the installations of a manufacturer or an operator, which are set up in a given geographical area and which are maintained by the operators.

From the installations there is a direct or indirect data connection to a central data processing station to which all operating data measured at the installations are transmitted and processed there. The data are for example the power output data, wind data and also temperature data of given units and so forth.

After the data are acquired, the data are evaluated and classified in respect of predetermined functions of the installations. Thus, the procedure firstly involves ascertaining from the operating data whether the installation is at all delivering power or is serviceable. That information is used as the basis when producing or updating an electronic overview.

If the installation is found not to be serviceable, a check is made to ascertain whether this is to be attributed to a technical failure. If that is the case, that information is also processed for producing or updating the overview. If however the situation does not involve a technical failure (technical failures are those failures which are to be attributed to the breakdown of certain technical elements of the installation such as rotor, generator, inverter, transformer and so forth), the procedure involves checking whether the deficiencies in serviceability are to be attributed to routine maintenance operations.

Such routine maintenance operations have to be carried out at certain intervals in relation to installations in order to guarantee reliable operation of the installations. When routine maintenance operations are being carried out, that information is also suitably further processed when producing the overview. If however no maintenance operations are also being implemented, the failure of the installations can be attributed to other reasons. Such a reason may also be that for example an installation within a wind part is admittedly serviceable but the connection to the whole of the wind park is faulty, because for example the entire connecting network is out of order or the operator of the connecting network has uncoupled the wind park from the connecting network, for technical reasons.

The respective items of information are processed in a block for symbol association for setting up an electronic overview. That block also involves processing for example basic map material, for example a geographical map of Germany, in electronic form.

As each installation is associated with a definite geographical position, it is now possible to produce a map in which a symbol is associated with each individual installation, wherein the shape and/or colour and/or representation of the symbol (for example flashing or not flashing) specify whether the installation is serviceable and if not, how the reason for non-serviceability thereof is classified, whether therefore the situation involves a technical failure or maintenance operations are being conducted or there is some other reason.

After the map has been produced and updated it is stored and outputted (FIG. 2) and made available for example to the Internet server of the manufacturer of the installations so that an interested party can obtain information about the entire ‘fleet’ of installations of the manufacturer/operator by clicking on predetermined symbols on the home page of the manufacturer/operator.

It will be appreciated that it is also possible that, when blending in the map and altering the symbols, the external shape of the symbols at the same time also symbolises the nature and/or the type of the installation.

Thus for example the symbol of a rectangle can mean that this involves wind power installations of a given type from the power class of about 500-600 kW while a round circle denotes an installation of a given type in the class of about 1.5-1.8 MW.

By touching the symbol of an installation or a wind park with a pointer such as for example a mouse pointer or by clicking or double clicking on the symbol, it is possible to display further selected, openly available items of information about the installation or the wind park.

In addition the symbols can involve a linking to the manufacturer and/or operator of the installation or the wind park. That makes it possible for third parties to implement a communication with the manufacturer/operator and exchange information in a simple fashion, for example by e-mail.

Further data can be made available for the operator of an installation or a wind park so that the operator can call up all data relevant to him about the network.

In order to prevent abuse of or unwanted or unauthorised viewing of confidential data, certain data can be stored in a separate (logical) region which is protected from unauthorised accesses by access control such as authentication or the like.

As an alternative to the above-described map production procedure it is also possible not to produce a geographical map—FIG. 2—but to record all installations in an overall overview list—FIG. 3—so that then those data appear without reference to geography in an overall overview list or table, from which then the viewer can immediately see how many installations of the manufacturer/operator are in operation and how many thereof are in turn also serviceable (or also not serviceable).

FIG. 2 shows by way of example a map of Germany (in symbolic form) with the symbols recorded thereon for individual installations. Therein the external shape of a symbol denotes a given type of an installation, for example a square stands for type E-40 (from Enercon), an installation from the power range of 500-600 kW, a circle stands for example for type E-66 (from Enercon), an installation from the power range of 1.5-1.8 MW, and a triangle stands for type E-30—an installation from the power range of 200-300 kW.

If a large number of installations are combined together in a wind park that can also be identified by a suitable independent (wind park) symbol.

The colouring of the symbols or their hatching or representation (for example rapidly, slowly or not flashing) symbolise the serviceability of the installation or, if that is not the case, the possible reason for the failure or outage. It is also possible in that way to indicate the deviation of predetermined key data or comparative values in order to signal the deviation.

FIG. 3 shows an alternative overview representation which however does not give the geographical reference of the installation. While the individual position of the installation can also be approximately seen in the map shown in FIG. 2, that reference is not to be found in the representation in FIG. 3. It will be noted however that the person looking at the overview illustrated in FIG. 3 can see more quickly than from the map in FIG. 2, what the situation is in regard to serviceability of the installations making up the ‘fleet’ of the manufacturer/operator who makes the information available on the Internet.

The respective maps or overviews can be produced by virtue of continuous operating data acquisition in up-to-date fashion, that is to say with the up-to-dateness of a day or less but also with the up-to-dateness of a week. The person looking at the map/overview can see therefrom, how reliable (or how unreliable) the installations of a given manufacturer/operator generally are and can form therefrom a judgment about the quality of the installations.

Besides the functional or operating data of the installations, it is also possible to specify, in relation to each installation, the wind data and/or the operating data of the individual installations or the data relating to the total amounts of energy delivered by the installation. It is particularly desirable to name not only the power availability—A—of the entire installation and ‘fleet’, but also the respectively produced amount—B—of electrical energy, in relation to given periods of time, for example a day, a month, a year and so forth.

In order to improve the clarity of the overview when dealing with a large number of different kinds of installation, at least one kind of installation and preferably each desired kind of installation can be cut out of the overview in order in that way to represent a smaller number of kinds of installation in the overview.

In that way the person looking at the situation can limit himself to the kind of installation which is relevant to him and in that way more quickly gains an impression of the situation of precisely that kind of installation. In that way it is possible to arrive at an overview for example of wind power installations or an overview of wind power installations and water treatment installations.

In addition, it is advantageously possible to implement a change in representation, for example from a geographically oriented overview, as shown in FIG. 2, to an overview set up in tabular form, as shown in FIG. 3, and vice-versa, in order to acquire an overview having regard to various criteria in respect of order, such as spatial arrangement (FIG. 2), or on the basis of statistical assessments, for example according to nature and type of the installations (FIG. 3).

In addition it is possible to facilitate contemporaneous representation of a plurality of similar views, that is to say for example views comparing the representation of a plurality of geographical regions side-by-side, in which case the size of each individual representation can be adapted to the needs of the person viewing same.

Alternatively various kinds of views such as tabular overviews and geographically oriented representations can be represented in side-by-side relationship.

1. A method of processing and representing the function of a plurality if installations, characterised by the following steps:
predetermined operating data, in particular those revealing the serviceability of an installation, are acquired in a data processing installation;
the acquired operating data are evaluated and classified;
the classification step includes ascertaining the information as to whether the installation is or is not serviceable and if not, what possible reason there is for the non-serviceability, for example a technical failure, maintenance operations or other reasons;
a symbol is associated with each installation or a group of installations;
the symbol classifies the e of the installation and/or the serviceability of the respective installation;
all symbols are combined to afford an overview (FIG. 2, FIG. 3) and are stored as an electronic file and outputted; and
the electronic file is outputted to a network server with which a given address is associated, by way of which it can be dialed to call up the file.

2. A method according to claim 1 characterised in that a geographical map is also utilised to produce the overview and the symbols are displayed at the location of the installation within the geographical maps, wherein the geographical map can be stored in its own file.

3. A method according to one of the preceding claims characterised in that the power data of the respective installations whose data are acquired are added up and displayed together with the overview, in relation to a given period of time, for example per day, per week, per month etc.

4. A method according to claim 3 characterised in that the sum (B) of the power data is related to the sum of the available power (A) of all similar installations whose operating data are acquired and evaluated and that said value is outputted together with the items of overview information or separately therefrom.

5. A method according to claim 4 characterised in that at least one selectable kind of installation can be cut out of the respectively selected overview.

6. A method according to one of the preceding claims characterised in that there is provided an access control which calls up at least authentication information, after the correct input of which further items of information are represented.

7. A method according to one of the preceding claims characterised in that a deviation from predeterminable limit values and/or comparative values influences the display.

8. A method according to one of the preceding claims characterised by contemporaneous representation of a plurality of similar and/or different kinds of overviews and/or the possibility of a change between a plurality of overviews, wherein the size of representation of at least one overview and preferably all overviews are variable.
